(19) United States
(12) Patent Application Publication
(10) Pub. No.: US 2017/0183536 A1
(43) Pub. Date: Jun. 29, 2017

(54) Interlayer Composition For Electronic Printing

(71) Applicant: Xerox Corporation, Norwalk, CT (US)

(72) Inventors: Guiqin Song, Milton (CA); Ping Liu, Mississauga (CA); Biby Esther Abraham, Mississauga (CA); Nan-Xing Hu, Oakville (CA); Adela Goredema, Ancaster (CA); Vladislav Skorokhod, Vaughan (CA)

(73) Assignee: Xerox Corporation

(21) Appl. No.: 14/981,419

(22) Filed: Dec. 28, 2015

(51) Int. Cl. C09D 179/04; B05D 1/02; B05D 1/00; B05D 1/18; C09D 163/00; C09D 125/18

(52) U.S. Cl. CPC C09D 179/04; C09D 163/00; C09D 125/18; B05D 1/005; B05D 1/18; B05D 1/02

(57) ABSTRACT

An interlayer composition including an epoxy resin; a polyvinyl phenol; a poly(melamine-co-formaldehyde) polymer; a solvent; an optional surfactant and an optional catalyst. A device including a substrate; an interlayer disposed thereon; and conductive features; wherein the interlayer is formed from a composition comprising an epoxy resin; a polyvinyl phenol; a poly(melamine-co-formaldehyde) polymer; an optional surfactant and an optional catalyst. A process for forming conductive features on a substrate including depositing an interlayer onto a substrate; thermally curing the interlayer; depositing a conductive composition onto the interlayer to form deposited features; and annealing the deposited features to form conductive features.

### BACKGROUND

Disclosed herein is an interlayer composition comprising an epoxy compound having at least two epoxy groups in one molecule, wherein the epoxy compound is free of aromatic moieties; a polyvinyl phenol; a melamine resin; a solvent; an optional surfactant, and an optional catalyst. Further disclosed is a device comprising a substrate; an interlayer; and conductive features; wherein the interlayer comprises a film formed from an interlayer composition comprising an epoxy compound having at least two epoxy groups in one molecule, wherein the epoxy compound is free of aromatic moieties; a polyvinyl phenol; a melamine resin; a solvent; an optional surfactant, and an optional catalyst. Further disclosed is a process for forming conductive features on a substrate comprising depositing an interlayer composition onto a substrate and forming a film from the interlayer composition, wherein the interlayer composition comprises an epoxy compound having at least two epoxy groups in one molecule, wherein the epoxy compound is free of aromatic moieties; a polyvinyl phenol; a melamine resin; a solvent; an optional surfactant, and an optional catalyst; curing the interlayer, in embodiments curing at a temperature of from about 80° C. to around 160° C. for about 30 minutes to about 5 hours; depositing a conductive composition onto the interlayer to form deposited features; and heating the deposited features to form conductive features. The interlayer composition can be disposed using solution processing methods.

Previously Xerox® Corporation developed silver nanoparticles and inks which can be solution processed by ink jet printing for various electronic device applications. Xerox® Corporation has invented a nanosilver particle which is stabilized by an organoamine U.S. Pat. No. 8,765,025, which is hereby incorporated by reference herein in its entirety, describes a metal nanoparticle composition that includes an organic-stabilized metal nanoparticle and a solvent in which the solvent selected has the following Hansen solubility parameters: a dispersion parameter of about 16 MPa^{0.5}, or more, and a sum of a polarity parameter and a hydrogen bonding parameter of about 8.0 MPa^{0.5} or less. U.S. Pat. No. 7,270,694, which is hereby incorporated by reference herein in its entirety, describes a process for preparing stabilized silver nanoparticles comprising reacting a silver compound with a reducing agent comprising a hydrazine compound by incrementally adding the silver compound to a first mixture comprising the reducing agent, a stabilizer comprising an organoamine, and a solvent.

U.S. patent application Ser. No. 13/866,704, which is hereby incorporated by reference herein in its entirety, describes stabilized metal-containing nanoparticles prepared by a first method comprising reacting a silver compound with a reducing agent comprising a hydrazine compound by incrementally adding the silver compound to a first mixture comprising the reducing agent, a stabilizer comprising an organoamine, and a solvent. U.S. patent application Ser. No. 14/188,284, which is hereby incorporated by reference herein in its entirety, describes conductive inks having a high silver content for gravure and flexographic printing and methods for producing such conductive inks.

Xerox® Corporation has developed flexographic and gravure inks based on silver nanoparticle technology. U.S. patent application Ser. No. 14/594,746, which is hereby incorporated by reference herein in its entirety, describes in the Abstract thereof a nanosilver ink composition including silver nanoparticles; polystyrene; and an ink vehicle. A process for preparing a nanosilver ink composition is described comprising combining silver nanoparticles; polystyrene; and an ink vehicle. A process for forming conductive features on a substrate using flexographic and gravure printing processes is described comprising providing a nanosilver ink composition comprising silver nanoparticles; polystyrene; and an ink vehicle; depositing the nanosilver ink composition onto a substrate to form deposited features; and heating the deposited features on the substrate to form conductive features on the substrate.

U.S. patent application Ser. No. 14/573,191, which is hereby incorporated by reference herein in its entirety, describes in the Abstract thereof a nanosilver ink composition including silver nanoparticles; a clay dispersion; and an ink vehicle. A process for forming conductive features on a substrate is described including providing a nanosilver ink composition comprising silver nanoparticles; a clay dispersion; and an ink vehicle; depositing the nanosilver ink composition onto a substrate to form deposited features; and heating the deposited features on the substrate to form conductive features on the substrate. Inks have been successfully formulated in non-polar solvents such as decalin and bicyclohexyl and successfully printed using inkjet printing technologies.

Solution processable conducting materials including silver nanoparticle inks play an important role in electronic device integrations. Silver nanoparticle inks can be easily dispersed in suitable solvents and used to fabricate various conducting features in electronic devices such as electrodes and electrical interconnectors by low-cost solution deposition and patterning techniques and especially by ink jet printing technologies.

The conductive features formed from metal nanoparticles such as silver nanoparticle inks on suitable substrates including glasses and flexible plastic substrates must have sufficient adhesion and mechanical robustness characteristics to enable proper electronic device fabrications and functions. However, one of the issues is that adhesion on certain substrates such as glasses and polyimide may not be adequate in some instances for robust device fabrications. The adhesion issue was tackled previously by addition of a small amount of polymeric materials including polyvinyl butyral (PVB) resin in silver conducting inks as an adhesion promoter. This approach is suitable for some applications. However, a potential disadvantage of this method is that the electrical conductivity of printed conductive features from such inks could, in some instances, be decreased significantly. Therefore, it is necessary to develop effective methods to improve adhesion and enable formation of devices with robust mechanical properties without sacrificing electric conductivity of metal nanoparticle inks used in electronic device applications.

Currently available compositions and methods are suitable for their intended purposes. However a need remains for improved electronic device compositions and methods. Further, a need remains for an improved method for providing sufficient adhesion and mechanical robustness characteristics while also maintaining desired electrical conductivity of the printed conductive features. Further, a need remains for an interlayer composition having the characteristics of film forming capability, adequate film adhesion, in embodiments, adequate film adhesion to glass substrates, ability to accept conductive ink, in embodiments silver ink, wherein a film formed from the interlayer allows desired adhesion of conductive ink to the film, non-polar solvent based silver ink wettability, and desired conductivity. In embodiments, what is desired is an interlayer composition providing a combination of these desired characteristics; that is, an interlayer composition that provides all of the following characteristics: film forming ability, film adhesion to glass, ink adhesion to film, non-polar solvent based ink wettability, and desired conductivity.

The appropriate components and process aspects of each of the foregoing U.S. patents and patent Publications may be selected for the present disclosure in embodiments thereof. Further, throughout this application, various publications, patents, and published patent applications are referred to by an identifying citation. The disclosures of the publications, patents, and published patent applications referenced in this application are hereby incorporated by reference into the present disclosure to more fully describe the state of the art to which this invention pertains.

### SUMMARY

Described is an interlayer composition comprising an epoxy compound of the formula

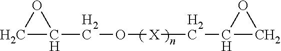

wherein X comprises from at least 2 to about 20 carbon atoms, an oxygen atom, and wherein X is free of aromatic moieties, and wherein n is from about 2 to about 20; a polyvinyl phenol; a melamine resin; a solvent; an optional surfactant; and an optional catalyst.

Also described is a device comprising a substrate; an interlayer; and conductive features; wherein the interlayer comprises a thermally cured film formed from an interlayer composition comprising an epoxy compound of the formula

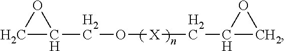

wherein X comprises from at least 2 to about 20 carbon atoms, an oxygen atom, and wherein X is free of aromatic moieties, and wherein n is from about 2 to about 20; a polyvinyl phenol; a melamine resin; a solvent; an optional surfactant; and an optional catalyst

Also described is a process for forming conductive features on a substrate comprising depositing an interlayer composition onto a substrate, wherein the interlayer composition comprises an epoxy compound of the formula

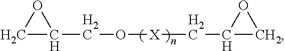

wherein X comprises from at least 2 to about 20 carbon atoms, an oxygen atom, and wherein X is free of aromatic moieties, and wherein n is from about 2 to about 20; a polyvinyl phenol; a melamine resin; a solvent; an optional surfactant; and an optional catalyst; forming a film from the interlayer composition by thermally curing the deposited interlayer composition; depositing a conductive composition onto the interlayer to form deposited features; and heating the deposited features to form conductive features.

### BRIEF DESCRIPTION OF THE DRAWINGS

FIG. 1 is an illustration of a printed silver ink line image on an uncoated glass substrate.

FIG. 2 is an illustration of a printed silver ink line image on an interlayer coated glass substrate in accordance with the present embodiments.

FIG. 3 is an illustration of printed ink line spreading on an interlayer composition in accordance with the present embodiments.

FIG. 4 is an illustration of printed ink line spreading on another interlayer composition in accordance with the present embodiments.

FIG. 5 is an illustration of surfactant effect on printed ink line spreading on an interlayer composition in accordance with the present embodiments.

FIG. 6 is an illustration of another surfactant effect on printed ink line spreading on an interlayer composition in accordance with the present embodiments.

FIG. 7 is an illustration of ink lines transferred to tape when ink lines were printed onto an uncoated glass substrate.

FIG. 8 is an illustration of ink lines that were not transferred to tape when the ink lines were printed onto an interlayer coated glass substrate in accordance with the present embodiments.

### DETAILED DESCRIPTION

In embodiments, electronic device compositions and methods are provided comprising interlayer compositions having sufficient adhesion and mechanical robustness characteristics while also maintaining desired electrical conductivity of the printed conductive features. Further, interlayer compositions are provided having the characteristics of film forming capability, adequate film adhesion, in embodiments, adequate film adhesion to glass substrates, ability to accept conductive ink, in embodiments silver ink, wherein a film formed from the interlayer allows desired adhesion of conductive ink to the film, aqueous nanoparticle inks, or non-polar solvent based silver ink wettability, and desired conductivity. In embodiments, interlayer compositions providing a combination of these desired characteristics are described; that is, interlayer compositions that provide all of the following characteristics: film forming ability, a smooth cured interlayer film surface, film adhesion to glass, ink adhesion to film, wettability of nanoparticle conductive ink including aqueous nanoparticle inks and non-polar solvent based nanoparticle silver inks, and desired conductivity.

The interlayer compositions can be employed for any suitable or desired application including, but not limited to, printable sensors or other electronic circuit devices for smart packaging. The interlayer compositions meet the requirements of ability to print electronic circuits on conventional surfaces such as polycarbonate, polyethylene terephthalate (PET), polyimide, polyethylene naphthalate (PEN), etc., while also exhibiting suitable adhesion and planarization characteristics, compatibility with electronic inks, and that do not require additional surface treatment. The interlayer compositions can be employed in multi-layer circuit printing and can be used to prepare electrical insulation layers.

An interlayer composition which can dramatically improve the adhesion between substrates and printed conductive layers constructed from various metal nanoparticle inks, including Xerox® silver nanoparticle inks, is provided. In embodiments, the interlayer composition comprises a mixture of epoxy resins (also known as polyepoxides), polyvinyl phenols, and poly(melamine-co-formaldehyde) based polymers. Optionally, a small amount of surface additives can be included to improve wetting and spreading properties. Further, an optional catalyst can be included to enhance the curing process.

In embodiments, the interlayer composition has properties including a viscosity of from about 2 centipoise (cps) to about 150 cps at about 25° C. and a surface tension of from about 18 mN/m (millinewtons per meter) to about 40 mN/m at about 25° C. In embodiments, the cured interlayer composition has a glass transition temperature of from about minus 10° C. to about 100° C. The low glass transition helps the nanoparticle ink adhesion on the interlayer film. In embodiments, the cured interlayer film also has a water contact angle of from about 65 degrees to about 95 degrees and the cured interlayer film surface roughness Ra is from about 1 nanometer to about 10 nanometers.

The interlayer can be fabricated by any suitable or desired process. In embodiments the interlayer can be prepared by solution process methods including spin coating, dip coating, inkjet printing, and the like, on various substrates, followed by annealing at suitable temperatures for curing.

The interlayer has very good adhesion on a variety of substrates including glass and polyimide.

The conductive features can be fabricated by any suitable or desired method. In embodiments, the conductive features can be prepared by solution processing techniques such as ink jet printing on the substrates with pre-applied interlayer.

The conductive features showed high conductivity with significantly improved adhesion after annealing at a suitable temperature.

The interlayer solution is stable and the coating can be cured at different temperatures. The interlayer composition can be cured at any suitable or desired temperature for any suitable period of time. In embodiments, the coated composition herein can be cured at a temperature of from about 80 to about 160° C., or from about 100 to about 140° C., or from about 120 to about 130° C. for a period of from about 0.5 to about 5 hours, or from about 1 to about 4 hours, or from about 2 to about 3 hours. In embodiments, the interlayer composition can be cured at about 160° C. for about 5 hours.

Since epoxy resins are excellent electrical insulators, the electrical conductivity of metal nanoparticle inks will not be affected by the present interlayer coating composition.

The resulting interlayer, after curing, provides a film having balanced properties for printing electronics including suitable water contact angle for controlling the ink wettability, surface smoothness, electrical insulating properties, suitable glass transition for controlling the flexibility for flexible electronics fabrications, and other properties as described herein.

The interlayer composition can include a polyvinylphenol (PVP) to provide film forming properties, an aliphatic epoxy compound which serves as a building block to enable specific structural properties, a curing component comprising a melamine resin, optionally, a surfactant, and a solvent. In embodiments, the interlayer composition is free of, that is, does not contain, hardening agents or hardening compounds.

In embodiments, an interlayer composition herein an epoxy compound of the formula

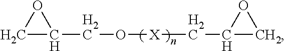

wherein X comprises from at least 2 to about 20 carbon atoms, an oxygen atom, and wherein X is free of aromatic moieties, and wherein n is from about 2 to about 20; a polyvinyl phenol; a melamine resin; a solvent; an optional surfactant; and an optional catalyst.

In one embodiment, X is of the formula

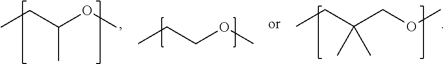

In certain embodiments, the epoxy compound is of the formula

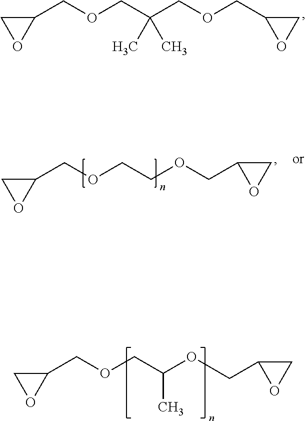

wherein n is from 1 to 10, or from 3 to 9.

The epoxy resin can be provided in the interlayer composition in any suitable or desired amount. In embodiments, the epoxy resin is present in an amount of from about 5 to about 45 percent, or from about 10 to about 35 percent, or from about 15 to about 25 percent, by weight, based on the total weight of the interlayer composition.

Any suitable or desired polyvinyl phenol can be selected for the present interlayer compositions. In embodiments, the polyvinyl phenol is selected from the group consisting of poly(4-vinylphenol), poly(vinylphenol)/poly(methyl acrylate), poly(vinylphenol)/poly(methyl methacrylate), poly(4-vinylphenol)/poly(vinyl methyl ketone), and combinations thereof.

In embodiments, a polyvinyl phenol having a weight average molecular weight Mw of from about 10,000 to about 50,000, or from about 15,000 to about 40,000, or from about 20,000 to about 30,000, is selected.

The polyvinyl phenol can be provided in the interlayer composition in any suitable or desired amount. In embodiments, the polyvinyl phenol is present in an amount of from about 0.5 to about 30 percent, or from about 1 to about 20 percent, or from about 2 to about 10 percent, by weight, based on the total weight of the interlayer composition.

The interlayer composition further contains a melamine resin. Any suitable or desired melamine resin can be selected for embodiments herein. In certain embodiments, the melamine resin is a poly(melamine-co-formaldehyde) copolymer. Any suitable or desired poly(melamine-co-formaldehyde) polymer can be selected for the present interlayer compositions. In embodiments, the poly(melamine-co-formaldehyde) is selected from the group consisting of methylated poly(melamine-co-formaldehyde), butylated poly(melamine-co-formaldehyde), isobutylated poly(melamine-co-formaldehyde), acrylated poly(melamine-co-formaldehyde), methylated/butylated poly(melamine-co-formaldehyde), and combinations thereof.

The poly(melamine-co-formaldehyde) polymer can be provided in the interlayer composition in any suitable or desired amount. In embodiments, the poly(melamine-co-formaldehyde) polymer is present in an amount of from about 0.5 to about 15 percent, or from about 1 to about 10 percent, or from about 2 to about 5 percent, by weight, based on the total weight of the interlayer composition.

The interlayer composition comprises from about 10 to about 50 weight percent solids, or from about 15 to about 40 weight percent solids, or from about 20 to about 30 weight percent solids, based on the total weight of the interlayer composition. In specific embodiments, the interlayer composition contains a selected solids content of less than about 30 weight percent solids, based on the total weight of the interlayer composition. For example, in embodiments, the interlayer composition contains a solids content of from about 10 to less than about 30 weight percent solids, or from about 15 to less than about 30 weight percent solids, or from about 20 to less than about 30 weight percent solids, based on the total weight of the interlayer composition.

Any suitable or desired solvent can be selected for the present interlayer compositions. In embodiments, the solvent is selected from the group consisting of propylene glycol methyl ether acetate, toluene, methyl isobutyl ketone, butylacetate, methoxypropylacetate, xylene, tripropyleneglycol monomethylether, dipropyleneglycol monomethylether, propoxylated neopentylglycoldiacrylate, and combinations thereof.

In embodiments, the solvent can be a non-polar organic solvent selected from the group consisting of hydrocarbons such as alkanes, alkenes, alcohols having from about 7 to about 18 carbon atoms such as undecane, dodecane, tridecane, tetradecane, hexadecane, 1-undecanol, 2-undecanol, 3-undecanol, 4-undecanol, 5-undecanol, 6-undecanol, 1-dodecanol, 2-dodecanol, 3-dedecanol, 4-dedecanol, 5-dodecanol, 6-dodecanol, 1-tridecanol, 2-tridecanol, 3-tridecanol, 4-tridecanol, 5-tridecanol, 6-tridecanol, 7-tridecanol, 1-tetradecanol, 2-tetradecanol, 3-tetradecanol, 4-tetradecanol, 5-tetradecanol, 6-tetradecanol, 7-tetradecanol, and the like; alcohols such as terpineol (α-terpineol), β-terpineol, geraniol, cineol, cedral, linalool, 4-terpineol, 3,7-dimethylocta-2,6-dien-1ol, 2-(2-propyl)-5-methyl-cyclohexane-1-ol; isoparaffinic hydrocarbons such as isodecane, isododecane; commercially available mixtures of isoparaffins such as Isopar™ E, Isopar™ G, Isopar™ H, Isopar™ L, Isopar™ V, Isopar™ G, manufactured by Exxon Chemical Company; Shellsol® manufactured by Shell Chemical Company; Soltrol® manufactured by Chevron Phillips Chemical Company; Begasol® manufactured by Mobil Petroleum Co., Inc.; IP Solvent 2835 manufactured by Idemitsu Petrochemical CO., Ltd; naphthenic oils; aromatic solvents such as benzene, nitrobenzene, toluene, ortho-, meta-, and para-xylene, and mixtures thereof; 1,3,5-trimethylbenzene (mesitylene); 1,2-, 1,3-, and 1,4-dichlorobenzene and mixtures thereof, trichlorobenzene; cyanobenzene; phenylcyclohexane and tetralin; aliphatic solvents such as isooctane, nonane, decane, dodecane; cyclic aliphatic solvents such as dicyclohexyl and decalin; and mixtures and combinations thereof.

In embodiments, two or more solvents can be used.

The solvent can be provided in the interlayer composition in any suitable or desired amount. In embodiments, the solvent is present in an amount of from about 50 to about 90 percent, or from about 60 to about 80 percent, or from about 70 to about 80 percent, by weight, based on the total weight of the interlayer composition.

Any suitable or desired surfactant can be selected for the present interlayer compositions. In embodiments, the surfactant is selected from the group consisting of a silicone modified polyacrylate, a polyester modified polydimethylsiloxane, a polyether modified polydimethylsiloxane, a polyacrylate modified polydimethylsiloxane, a polyester polyether modified polydimethylsiloxane, a low molecular weight ethoxylated polydimethylsiloxane, polyether modified polydimethylsiloxane, polyester modified polymethylalkylsiloxane, polyether modified polymethylalkylsiloxane, aralkyl modified polymethylalkylsiloxane, polyether modified polymethylalkylsiloxane, polyether modified polydimethylsiloxane, and combinations thereof.

In embodiments, the surfactant is a solvent based siloxane. In embodiments, the surfactant is a silicone modified polyacrylate. In embodiments, the concentration of the surfactant can be from about 0.01 weight percent to about 2 weight percent, or from about 0.1 weight percent to about 1.5 weight percent, or from about 0.5 weight percent to about 1 weight percent. The surfactant can be a polysiloxane copolymer that includes a polyester modified polydimethylsiloxane, commercially available from BYK Chemical with the trade name of BYK® 310; a polyether modified polydimethylsiloxane, commercially available from BYK Chemical with the trade name of BYK® 330; a polyacrylate modified polydimethylsiloxane, commercially available from BYK Chemical with the trade name of BYK®-SILCLEAN 3700 (about 25 weight percent in methoxypropylacetate); or a polyester polyether modified polydimethylsiloxane, commercially available from BYK Chemical with the trade name of BYK® 375. The surfactant can be a low molecular weight ethoxylated polydimethylsiloxane with the trade name Silsurf® A008 available from Siltech Corporation. For further detail, see U.S. patent application Ser. No. 13/716,892, filed Dec. 17, 2012, of Liu et al., which is hereby incorporated by reference herein in its entirety.

In embodiments, the surfactant is present and is selected from the group consisting of a polyester modified polydimethylsiloxane, a polyether modified polydimethylsiloxane, a polyacrylate modified polydimethylsiloxane, a polyester polyether modified polydimethylsiloxane, a low molecular weight ethoxylated polydimethylsiloxane, and combinations thereof.

The surfactant can be provided in the interlayer composition in any suitable or desired amount. In embodiments, the surfactant is present in an amount of from about 0.01 to about 2 percent, from about 0.1 to about 1.5 percent, or from about 0.5 to about 1 percent, by weight, based on the total weight of the interlayer composition.

The interlayer composition can optionally comprise a catalyst. Any suitable or desired catalyst can be selected for the present interlayer compositions. In embodiments, the catalyst is selected from the group consisting of amine salts of dodecylbenzene sulfonic acid (DDBSA), para toluene sulfonic acid, trifluoromethane sulfonic acid, and combinations thereof.

The catalyst can be provided in the interlayer composition in any suitable or desired amount. In embodiments, the catalyst is present in an amount of from about 0.05 to about 1.5 percent, or from about 0.08 to about 1.0 percent, or from about 0.1 to about 0.5 percent, by weight, based on the total weight of the interlayer composition.

In embodiments, a device is provided comprising a substrate; an interlayer; and conductive features; wherein the interlayer comprises a film, in embodiments a thermally cured film, formed from an interlayer composition comprising an epoxy compound of the formula

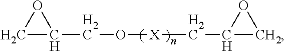

wherein X comprises from at least 2 to about 20 carbon atoms, an oxygen atom, and wherein X is free of aromatic moieties, and wherein n is from about 2 to about 20; a polyvinyl phenol; a melamine resin; a solvent; an optional surfactant; and an optional catalyst.

The device can be prepared by any suitable or desired method. In embodiments, a process for forming conductive features on a substrate comprises depositing an interlayer onto a substrate; curing the interlayer to form an interlayer film; depositing a conductive composition onto the interlayer film to form deposited features; heating (or annealing) the deposited features to form conductive features.

Any suitable or desired material can be used to form the conductive features. In embodiments, a metal nanoparticle ink composition is selected. Xerox Corporation has developed ink jet inks, flexographic inks, and gravure inks based on silver nanoparticle technology. These inks can be selected for embodiments herein. U. S. Patent Publication 2014/0312284 (application Ser. No. 13/866,704, which is hereby incorporated by reference herein in its entirety, describes in the Abstract thereof a nanosilver ink composition including silver nanoparticles; a small amount of polymeric material (optional) and an ink vehicle. A process for preparing a nanosilver ink composition is described comprising combining silver nanoparticles, a small amount of polymeric material (optional) and an ink vehicle. A process for forming conductive features on a substrate using ink jet printing processes is described comprising providing a nanosilver ink composition comprising silver nanoparticles; a small amount of polymeric material (optional) and an ink vehicle; depositing the nanosilver ink composition onto a substrate to form deposited features; and heating the deposited features on the substrate to form conductive features on the substrate.

U.S. Pat. No. 8,324,294, which is hereby incorporated by reference herein in its entirety, describes in the Abstract thereof a nanosilver ink composition including silver nanoparticles; a resin; and an ink vehicle. A process for forming conductive features on a substrate is described including providing a nanosilver ink composition comprising silver nanoparticles, a resin and an ink vehicle; depositing the nanosilver ink composition onto a substrate to form deposited features; and heating the deposited features on the substrate to form conductive features on the substrate. Inks have been successfully formulated in non-polar solvents such as decalin and bicyclohexyl and successfully printed using inkjet printing technologies.

The interlayer and any layer or layers including conductive layers disposed thereon can be provided using any suitable or desired method. In embodiments, depositing the interlayer comprises solution depositing the interlayer, and wherein, in embodiments, solution depositing comprises a method selected from the group consisting of spin coating, dip coating, spray coating, slot die coating, flexographic printing, offset printing, screen printing, gravure printing, ink jet printing, and combinations thereof.

The depositing of the interlayer composition, and/or the optionally the nanoparticle ink composition or other layers provided on the device, may be performed for example, by solution depositing. Solution depositing, for example, refers to a process where a liquid is deposited upon the substrate to form a coating or layer. This is in contrast to vacuum depositing processes. The present processes are also different from other solution-based processes, for example electroplating, which requires a plate to remain immersed in a solution and also requires exposure to an electric current to form a metal coating on the plate. The present process also offers several advantages compared to other process such as the decreasing the amount of waste and decreasing the amount of time necessary to coat a substrate. Solution depositing includes, for example, spin coating, dip coating, spray coating, slot die coating, flexographic printing, offset printing, screen printing, gravure printing, or ink jet printing the interlayer composition onto the substrate.

The film formed from the interlayer composition can be coated at any suitable or desired thickness. In embodiments, the dried film thickness of the interlayer is from about 0.2 to about 5 micrometers, or from about 0.5 to about 3 micrometers, or from about 0.75 to about 1 micrometers. In a specific embodiment, the coating thickness of the interlayer is from about 0.2 to about 1 micrometer.

The device can possess, in embodiments, the properties of the interlayer composition and film formed therefrom as described herein. In embodiments, the device includes a thermally cured film prepared from the interlayer composition wherein the thermally cured film possesses a water contact angle of from about 65 degrees to about 95 degrees. In embodiments, the thermally cured film possesses a surface roughness of form about 1 nanometer to about 10 nanometers. In embodiments, the thermally cured film has a glass transition temperature of from about minus 10° C. to about 100° C. In embodiments, the thermally cured film has a thickness of from about 0.1 micron (micrometer) to about 5 microns (micrometers).

The device and process herein can comprise forming conductive features from a metal ink composition. In embodiments, the conductive composition comprises a metal nanoparticle ink composition. The fabrication of conductive features, such as an electrically conductive element, from a metal ink composition, for example, from a nanoparticle metal ink, such as a nanosilver ink composition, can be carried out by depositing the composition on a substrate using any suitable deposition technique including solution processing and flexographic and gravure printing processes at any suitable time prior to or subsequent to the formation of other optional layer or layers on the substrate. Thus deposition of the ink composition on the substrate can occur either on a substrate or on a substrate already containing layered material, for example, a substrate having disposed thereon the present interlayer composition.

The substrate may be any suitable substrate including silicon, glass plate, plastic film, sheet, fabric, or synthetic paper. For structurally flexible devices, plastic substrates such as polyester, polycarbonate, polyimide sheets, polyethylene terephthalate (PET) sheet, polyethylene naphthalate (PEN) sheet, and the like, may be used. The thickness of the substrate can be any suitable thickness such as about 10 micrometers to over 10 millimeters with an exemplary thickness being from about 50 micrometers to about 2 millimeters, especially for a flexible plastic substrate, and from about 0.4 to about 10 millimeters for a rigid substrate such as glass or silicon. In embodiments, the substrate is selected from the group consisting of silicon, glass plate, plastic film, sheet, fabric, paper, and combinations thereof.

In embodiments, a device herein can comprise a substrate, an interlayer disposed thereover, and a conductive ink composition disposed over the interlayer.

Heating the deposited conductive ink composition can be to any suitable or desire temperature, such as to from about 70° C. to about 200° C., or any temperature sufficient to induce the metal nanoparticles to “anneal” and thus form an electrically conductive layer which is suitable for use as an electrically conductive element in electronic devices. The heating temperature is one that does not cause adverse changes in the properties of previously deposited layers or the substrate. In embodiments, use of low heating temperatures allows use of low cost plastic substrates which have an annealing temperature of below 140° C.

The heating can be for any suitable or desire time, such as from about 0.01 second to about 10 hours. The heating can be performed in air, in an inert atmosphere, for example under nitrogen or argon, or in a reducing atmosphere, for example, under nitrogen containing from about 1 to about 20 percent by volume hydrogen. The heating can also be performed under normal atmospheric pressure or at a reduced pressure of, for example, about 1000 mbars to about 0.01 mbars.

Heating encompasses any technique that can impart sufficient energy to the heated material or substrate to (1) anneal the metal nanoparticles and/or (2) remove the optional stabilizer from the metal nanoparticles. Examples of heating techniques include thermal heating (for example, at hot plate, an oven, and a burner), infra-red (“IR”) radiation, laser beam, flash light, microwave radiation, or ultraviolet (“UV”) radiation, or a combination thereof.

In embodiments, after heating, the resulting electrically conductive line has a thickness ranging from about 0.1 to about 20 micrometers, or from about 0.15 to about 10 micrometers. In certain embodiments, after heating, the resulting electrically conductive line has a thickness of from about 0.1 to about 2 micrometers.

The conductivity of the resulting metal element produced by heating the deposited metal ink composition is, for example, more than about 100 Siemens/centimeter (S/cm), more than about 1,000 S/cm, more than about 2,000 S/cm, more than about 5,000 S/cm, more than about 10,000 S/cm, or more than about 50,000 S/cm.

The resulting elements can be used for any suitable or desired application, such as for electrodes, conductive pads, interconnects, conductive lines, conductive tracks, and the like, in electronic devices such as thin film transistors, organic light emitting diodes, RFID tags, photovoltaic, displays, printed antenna, and other electronic devise which required conductive elements or components.

### Examples

The following Examples are being submitted to further define various species of the present disclosure. These Examples are intended to be illustrative only and are not intended to limit the scope of the present disclosure. Also, parts and percentages are by weight unless otherwise indicated.

Interlayer Components.

Neopentyl glycol diglycidyl ether (NPGDE) from Sigma Aldrich.

Bisphenol A diglycidyl ether (BPADE) from Sigma Aldrich.

Poly(propylene glycol) diglycidyl ether (PLGDE) from Sigma Aldrich. Average number molecular weight Mn is about 380.

Poly(4-vinylphenol) (PVP) from Sigma Aldrich, around 25,000 molecular weight

Poly(melamine co-formaldehyde), methylated 84 weight percent solution in 1-butanol (PMMF) from Sigma Aldrich.

BYK®-SILCLEAN 3700, from BYK, solution of a OH-functional silicone modified polyacrylate.

Propylene glycol methyl ethyl acetate (PGMEA) solvent from Sigma Aldrich

Preparation of Interlayer Solution.

Interlayer composition Examples 1-5 were prepared having the components provided in the percentage of each component as shown in Table 1. The interlayer compositions of Examples 6 and 7 and Comparative Examples 8 and 9 were prepared having the components provided in the amounts shown in Table 2. The interlayer solution was prepared according to the following steps.

Step 1.

Prepare 10 to 30% PVP solution: put 70 to 90 grams propylene glycol methyl ethyl acetate (PGMEA) solvent in a glass bottle, then slowly add 10 to 30 grams PVP into the solvent with magnetic stirring at a speed of about 250 rpm/minute to around 500 rpm/minute. Keep the stirring for around one to two hours until PVP is totally dissolved in PGMEA solvent and the solution is clear.

Step 2.

Combine all the components. The components were combined in a glass bottle in the amounts shown, as follows. Load the rest of the solvent in glass bottle first, add epoxy resin and let the resin totally dispersed in the solvent, then load PMMF and make sure the PMMF is also dispersed in the mixture before loading the PVP solution, Roll-mill the mixture at 175 RPM for at least 2 hours.

Silver Nanoparticle Ink Composition.

A silver nanoparticle ink was prepared as described in U. S. Patent Publication 2014/0312284 (application Ser. No. 13/866,704, which is hereby incorporated by reference herein in its entirety.

The silver nanoparticle ink composition was prepared by mixing silver nanoparticle powders with a solvent mixture of bicyclohexane and phenylcyclohexane at a 3:2 ratio. The silver nanoparticles are 50 weight percent of the silver formulation. After the silver nanoparticles were mixed into the solvents, the composition was filtered using a 1.0 μm syringe filter. The composition was printed using a DMP-2800 ink jet printer equipped with 10 pL cartridges. After printing and thermal annealing, the highly conductive features were formed.

TABLE 1

| | | | | | | Silclean | | Total |
|---|---|---|---|---|---|---|---|---|
| | NPGDE | BPADE | PLGDE | PVP | PMMF | 3700 | PGMEA | Solid |
| Example | (wt %) | (wt %) | (wt %) | (wt %) | (wt %) | (wt %) | (wt %) | (wt %) |
| 1 | 5.33 | 5.33 | 0.00 | 3.99 | 5.59 | 0.13 | 79.63 | 20.37 |
| 2 | 6.25 | 6.25 | 0.00 | 3.12 | 5.25 | 0.00 | 79.13 | 20.87 |
| 3 | 6.24 | 6.24 | 0.00 | 3.12 | 5.24 | 0.16 | 79.00 | 21.00 |
| 4 | 6.78 | 6.78 | 0.00 | 2.55 | 5.69 | 0.00 | 78.20 | 21.80 |
| 5 | 0.00 | 0.00 | 5.40 | 9.20 | 2.70 | 0.00 | 82.70 | 17.30 |

The curing conditions for Examples 1-4 were 120° C. for 30 minutes. The curing conditions for Example 5 were 160° C. for 5 hours.

Interlayer composition Examples 6 and 7 and Comparative Examples 8 and 9 were prepared having the components provided in the amounts as shown in Table 2 where percent is percent by weight.

TABLE 2

| Example | Epoxy Chemical Structure | Interlayer Formulation |
|---|---|---|
| 6 | 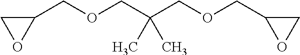 | 2.54% PVP, 5.69% PMMF, 13.56% NPGDE, and 78.21% PGMEA (Total Solids 21.79%) |
| 7 | 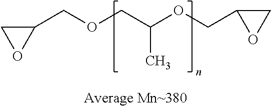 | 2.65% PVP, 2.95% PMMF, 14.1% PLGDE, 80.3% PGMEA (Total Solids 19.7%) |
| Comparative Example 8 | 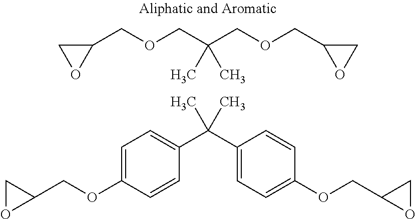 | 3.13% PVP, 5.25% PMMF, 6.25% NPGDE, 6.25% BADGE, 79.12% PGMEA (Total Solids 20.88%) |
| Comparative Example 9 | 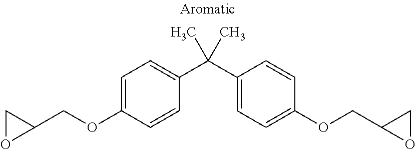 [SMILES: CC(C)(c1ccc(OCC2CO2)cc1)c1ccc(OCC2CO2)cc1] | 2.54% PVP, 5.69% PMMF, 13.56% BADGE, 78.21% PGMEA (Total Solids 21.8%) |

Spin Coating and Curing Process.

The coating solution of each Example 1-7 and Comparative Examples 8-9 was coated on microscope pre-cleaned glass using an SCS P6700 Spin Coater. The coating speed was set at 100 rpm for 5 seconds, then increased up to 1600 rpm and kept at this speed for 60 seconds. The coated samples were then put on a hot plate or put in an oven at 120° C. and cured from 30 minutes to 5 hours as shown in Table 1.

Printing Process and Characterization.

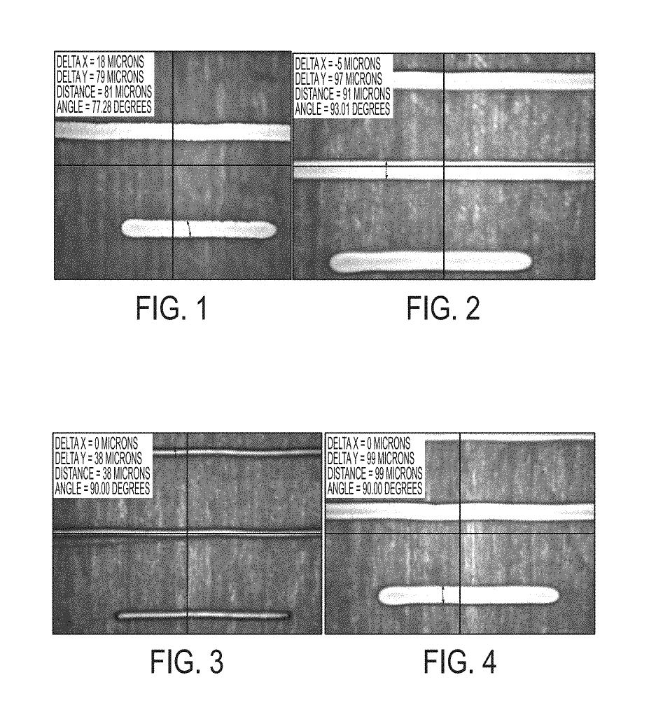

The silver nanoparticle ink described above was printed using a Dimatix DMP2800 equipped with a 10 pL cartridge and all nozzles worked perfectly, forming spherical drops. Line widths of about 70-80 microns were printed onto uncoated and interlayer coated glass. The interlayers of Examples 1-9 were provided at a thickness of from about 100 nanometers to about 1000 nanometers. When printed on uncoated and interlayer coated glass, as shown in FIG. 1 (uncoated glass) and FIG. 2 (interlayer coated glass), straight lines with uniform edges were obtained. No deformation in line shape was observed upon thermal sintering. All printed lines were highly conductive after annealing at about 120° C. to about 160° C. for about 30 to about 300 minutes. However, the interlayer film formulated with loading Bisphenol A diglycidyl ether (BPADE) has poor adhesion on substrates especially on glass.

FIG. 3 and FIG. 4 demonstrate that the silver ink spreading can be controlled by interlayer formulation. For example, ink spreading can be controlled by selection of epoxy/PVP ratio, PMMF/PVP ratio, and surfactant loading, as well as by curing condition and other process selections. In FIGS. 3 and 4, an ink composition as described above was printed as described above at a line width of about 70-80 microns.

FIG. 3 shows ink spreading on an interlayer coated substrate comprising the interlayer of Example 1 coated on a glass substrate. The dried film of the interlayer has a thickness of about 200 nanometers.

FIG. 4 shows ink spreading on an interlayer coated substrate comprising the interlayer of Example 4 coated on a glass substrate. The interlayer was coated at a thickness of about 200 nanometers.

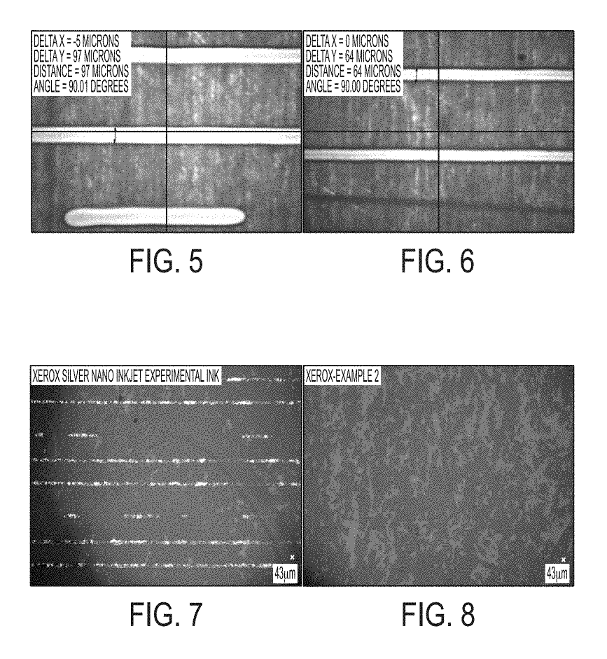

FIG. 5 and FIG. 6 show an ink spreading comparison and the surfactant effect on different interlayer compositions and ink spreading. FIG. 5 shows the interlayer formulation of Example 2. FIG. 6 shows the interlayer formulation of Example 3.

After printing and annealing at 120° C. for 30 minutes, the printed lines were subjected to an adhesion test by sticking Scotch® Magic™ Tape (3M) to the surface of the conductive lines, and then peeling the Scotch® Magic™ tape off of the surface. The peeled tape was attached to a Xerox® 4200 paper. When no interlayer was used, the adhesion was very poor and a large amount of ink lines were peeled off as shown in FIG. 7. In contrast, for the glass coated with the interlayer of the present embodiments of Examples 1-4, the ink adhesion was very good. As shown in FIG. 8, none of the silver ink lines were peeled off.

Properties of the interlayer compositions of Examples 6 and 7 and Comparative Examples 8 and 9 were measured. Film forming property was determined by use of a Scan Electron Microscope (SEM) and observing whether a film was formed.

Film Adhesion to glass substrate was characterized by sticking Scotch® Magic™ Tape (3M) to the surface of the coated film and visually evaluating if the coated film was peeled off.

Silver ink adhesion to the interlayer film was also characterized by sticking Scotch® Magic™ Tape (3M) to the surface of the printed silver line and visually evaluating if the printed silver line was peeled off.

Nano conductive ink wettability on the interlayer composition was measured by the printing line width. The printing quality was characterized by the resolution of the printed line.

The conductivity was calculated based on the resistivity measurement. Resistivity=ohms×height×width/length, Conductivity=1/resistivity. The resistance of the printed line was measured using a Keithley SCS-4200. Step height and width of the printed line were measured using a Bruker DektakXT Surface Profilometer.

The properties of Examples 6 and 7 and Comparative Examples 8 and 9 are shown in Table 3.

TABLE 3

| | Properties | | | | |
|---|---|---|---|---|---|
| | | Film | | Non-polar | |
| | | Adhe- | Silver | Solvent | Conductivity |
| | Film | sion | Ink | Based | (After Cured at |
| | Form- | to | Adhesion | Silver Ink | 160° C. for 5 |
| Example | ing | Glass | to Film | Wettability | hours) |
| 6 | ◯ | Δ | X | ◯ | ◯ |
| 7 | ◯ | ◯ | ◯ | ◯ | ◯ |
| Compar- | ◯ | X | X | ◯ | N/A |
| ative | | | | | |
| Example 8 | | | | | |
| Compar- | X | X | X | X | N/A |
| ative | | | | | |
| Example 9 | | | | | |

wherein ◯ indicates the presence of the property;
Δ indicates partial presence of the property;
X indicates the absence of the property; and
N/A indicates the date was not collected.

As can be seen by the results in Table 3, Examples 6 and 7 of the present embodiments containing aliphatic epoxy compounds exhibit all or a majority of the desired properties. Comparative Example 8 containing a combination of aliphatic and aromatic epoxy compounds possesses only two of the desired properties. Comparative Example 9 containing an aromatic epoxy compound did not possess any of the desired properties.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

1. An interlayer composition comprising:
an epoxy compound of the formula 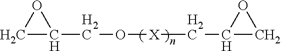
wherein X comprises from at least 2 to about 20 carbon atoms, an oxygen atom, and wherein X is free of aromatic moieties, and wherein n is from about 2 to about 20;
a polyvinyl phenol;
a melamine resin;
a solvent;
an optional surfactant; and
an optional catalyst.

2. The interlayer composition of claim 1:
wherein X is of the formula

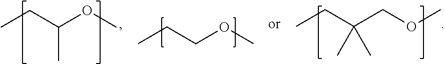

3. The interlayer composition of claim 1:
wherein the epoxy compound is of the formula 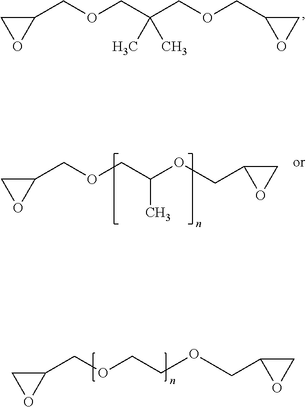
wherein n is from 1 to 10.

4. The interlayer composition of claim 1:
wherein the polyvinyl phenol is selected from the group consisting of poly(4-vinylphenol), poly(vinylphenol)/poly(methyl acrylate), poly(vinylphenol)/poly(methyl methacrylate), poly(4-vinylphenol)/poly(vinyl methyl ketone), and combinations thereof.

5. The interlayer composition of claim 1, wherein the melamine resin is a poly(melamine-co-formaldehyde) polymer.

6. The interlayer composition of claim 5:
wherein the poly(melamine-co-formaldehyde) polymer is selected from the group consisting of methylated poly(melamine-co-formaldehyde), butylated poly(melamine-co-formaldehyde), isobutylated poly(melamine-co-formaldehyde), acrylated poly(melamine-co-formaldehyde), methylated/butylated poly(melamine-co-formaldehyde), and combinations thereof.

7. The interlayer composition of claim 1:
wherein the solvent is selected from the group consisting of propylene glycol methyl ether acetate, toluene, methyl isobutyl ketone, butylacetate, methoxypropylacetate, xylene, tripropyleneglycol monomethylether, dipropyleneglycol monomethylether, propoxylated neopentylglycoldiacrylate, and combinations thereof.

8. The interlayer composition of claim 1:
wherein the interlayer composition has a solids content of from about 10 weight percent to about 50 weight percent based on the total weight of the interlayer composition.

9. The interlayer composition of claim 1:
wherein the surfactant is present and is selected from the group consisting of a silicone modified polyacrylate, a polyester modified polydimethylsiloxane, a polyether modified polydimethylsiloxane, a polyacrylate modified polydimethylsiloxane, a polyester polyether modified polydimethylsiloxane, a low molecular weight ethoxylated polydimethylsiloxane, and combinations thereof.

10. The interlayer composition of claim 1, wherein the interlayer composition has a surface tension of from about 18 mN/m to about 40 mN/m at about 25° C.

11. The interlayer composition of claim 1, wherein the interlayer composition has a viscosity of from about 2 cps to about 150 cps at about 25° C.

12. A device comprising:
a substrate;
an interlayer; and
conductive features;
wherein the interlayer comprises a thermally cured film formed from an interlayer composition comprising an epoxy compound of the formula 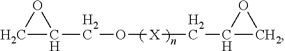
wherein X comprises from at least 2 to about 20 carbon atoms, an oxygen atom, and wherein X is free of aromatic moieties, and wherein n is from about 2 to about 20;
a polyvinyl phenol;
a melamine resin;
a solvent;
an optional surfactant; and
an optional catalyst.

13. The device of claim 12, wherein the substrate is selected from the group consisting of silicon, glass plate, plastic film, sheet, fabric, synthetic paper, and combinations thereof.

14. The device of claim 12, wherein the conductive features comprise an electrically conductive element formed from a nanoparticle conductive ink composition.

15. The device of claim 12, wherein the thermally cured film possesses a water contact angle of from about 65 degrees to about 95 degrees.

16. The device of claim 12, wherein the thermally cured film possesses a surface roughness of from about 1 nanometer to about 10 nanometers.

17. The device of claim 12, wherein the thermally cured film has a glass transition temperature of from about minus 10° C. to about 100° C.

18. The device of claim 12, wherein the thermally cured film has a thickness of from about 0.1 micron to about 5 microns.

19. A process for forming conductive features on a substrate comprising:
depositing an interlayer composition onto a substrate, wherein the interlayer composition comprises an epoxy compound of the formula 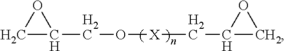
wherein X comprises from at least 2 to about 20 carbon atoms, an oxygen atom, and wherein X is free of aromatic moieties, and wherein n is from about 2 to about 20; a polyvinyl phenol; a melamine resin; a solvent; an optional surfactant; and an optional catalyst;
forming a film from the interlayer composition by thermally curing the deposited interlayer composition;
depositing a conductive composition onto the interlayer to form deposited features; and
heating the deposited features to form conductive features.

20. The process of claim 19, wherein depositing the interlayer comprises solution depositing the interlayer, and wherein the solution depositing comprises a method selected from the group consisting of spin coating, dip coating, spray coating, slot die coating, flexographic printing, offset printing, screen printing, gravure printing, ink jet printing, and combinations thereof.
